(19) United States
(12) Patent Application Publication
(10) Pub. No.: US 2010/0133878 A1
(43) Pub. Date: Jun. 3, 2010

(54) FLOOR MODULE

(75) Inventors: Samar R. Teli, Rochester Hills, MI (US); Allan James, Oxford, MI (US); Blair S. Patty, Midland, MI (US)

Correspondence Address: THE DOW CHEMICAL COMPANY;REISING, ETHINGTON, BARNES, KISSELLE, LEARMAN &, LEARMAN & MCCULLOCH, P.O. BOX 4390, TROY, MI, 48099-4390, US

(73) Assignee: Dow Gobal Technologies Inc., Midland, MI (US)

(21) Appl. No.: 12/518,547

(22) PCT Filed: Dec. 18, 2007
(86) PCT No.: PCT/US07/87906

§ 371 Date: Jan. 13, 2010

Related U.S. Application Data
(60) Provisional application No. 60/875,752, filed on Dec. 19, 2006.

(51) Int. Cl. B62D 25/20; B32B 37/14

(52) U.S. Cl. 296/193.07; 156/242

(57) ABSTRACT

A floor module (10) and method of inserting a floor module are provided. The floor module comprises a floor section (18) and a pair of side walls (20) at the peripheral edges of the floor section. The side walls (14) are adhesively secured to the side rails of the vehicle load bearing structure (12). A damper (30) is applied to the bottom of the floor section. The floor module (10) is inserted into the vehicle during the assembly process. Heat activated adhesives (24, 28) secure the floor module to the loading bearing structure (12) of the vehicle during an e-coating process.

### CROSS-REFERENCE TO RELATED APPLICATION

The instant application claims priority to U.S. Provisional Application Ser. No. 60/875,752 filed 19 Dec. 2006, the entire specification of which is expressly incorporated herein by reference.

### FIELD OF THE INVENTION

The present invention relates to a floor module for motor vehicles.

### DESCRIPTION OF THE RELATED ART

Presently, vehicle floor pans are typically made of metal and are stamped of several pieces. Often, four or more sections are separately stamped and these sections are placed in the vehicle. The floor pan sections span between the vehicle's fire wall and the vehicle's spare wheel well. The vehicle floor pan sections are typically secured to the load bearing structure of a vehicle by welding. The floor pan sections can be placed in vehicles having a load bearing structure of the rail type, or the load bearing structure can be of the unitized body type. In each case, the load bearing structure includes die rails extending the longitudinal length of the vehicle. Cross members extend perpendicular to and between the side rails to provide further support. Further, many mounting brackets or attachment plates are affixed to or adjacent the side rails and lower cross members. These brackets must be welded to the vehicle load bearing structure. The current vehicle floor pan assemblies are susceptible to corrosion, are noisy, and are relatively difficult to assemble and install in a vehicle.

U.S. Pat. No. 6,739,641 is assigned to the assignee of the present invention and comprises and comprises a composite spare wheel well. The patent discloses a vehicle wheel well assembly that is adapted for connection with a vehicle floor pan. The wheel well assembly is formed as a unitary member.

United States Patent Application Publication No. 2005/0127716 is assigned to the assignee of the present invention and shows modular vehicle floor compartments. The modular compartments comprise a series of compartments arranged within a vehicle. The compartments are connected to a support structure of a vehicle.

U.S. Pat. No. 6,375,247 to Volz, et al discloses a body of a motor vehicle with a seat module. The seat module is separately formed and inserted as a prefabricated unit into a load bearing structure of the body in such a way that a floor part in the region of the seat module forms a double floor with the vehicle floor of the body.

U.S. Pat. No. 6,843,336 to Chernoff et al discloses a vehicle belly pan. The vehicle chassis has substantially all of the mechanical, electrical and structural compartments necessary for a fully functioning vehicle.

United States Patent Application Publication No. 2005/0040675 shows a floor module for a vehicle. The floor module comprises a floor plate that is cut to size and ready for installation to a mounting rail.

German Patent No. DE 196 08 127 A1 discloses a method for manufacturing a fiber composite component. The component may comprise a motor vehicle floor.

### SUMMARY OF THE INVENTION

According to one embodiment of the present invention, there is provided a floor module for disposition in a vehicle having a load bearing structure. The load bearing structure has side rails and at least one lower cross member disposed between the side rails. The floor module comprises a floor section for disposition on the load bearing structure to comprise the floor of the vehicle. The floor module further comprises at least one wall extending transversely from said floor section and adapted to be secured to the load bearing structure. The wall includes a mounting flange portion having an adhesive layer on at least a portion thereof. The adhesive layer adapted to secure said module to the load bearing surface.

According to another embodiment of the present invention, there is provided a method of constructing a floor module and securing the floor module in a vehicle having a load bearing structure. The load bearing structure has side rails and at least one lower cross member disposed between the side rails. The method comprises the steps of molding a floor section and at least one wall extending transversely to the floor section. The method further comprises placing a heat activated adhesive film on at least a portion of the at least one wall. The method further comprises placing the module in a vehicle so that the at least one wall and the adhesive film contact the lead bearing structure. The method further comprises e-coating at least a portion of the module and simultaneously activating the adhesive film to thereby secure the floor module to the load bearing structure.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is perspective view of one embodiment of the present invention;

FIG. 2 is an exploded view of a cross-sectional view taken along lines 2-2 of FIG. 1; and

FIG. 3 is a perspective view of an alternative embodiment of the present invention.

### DETAILED DESCRIPTION OF THE PREFERRED EMBODIMENT

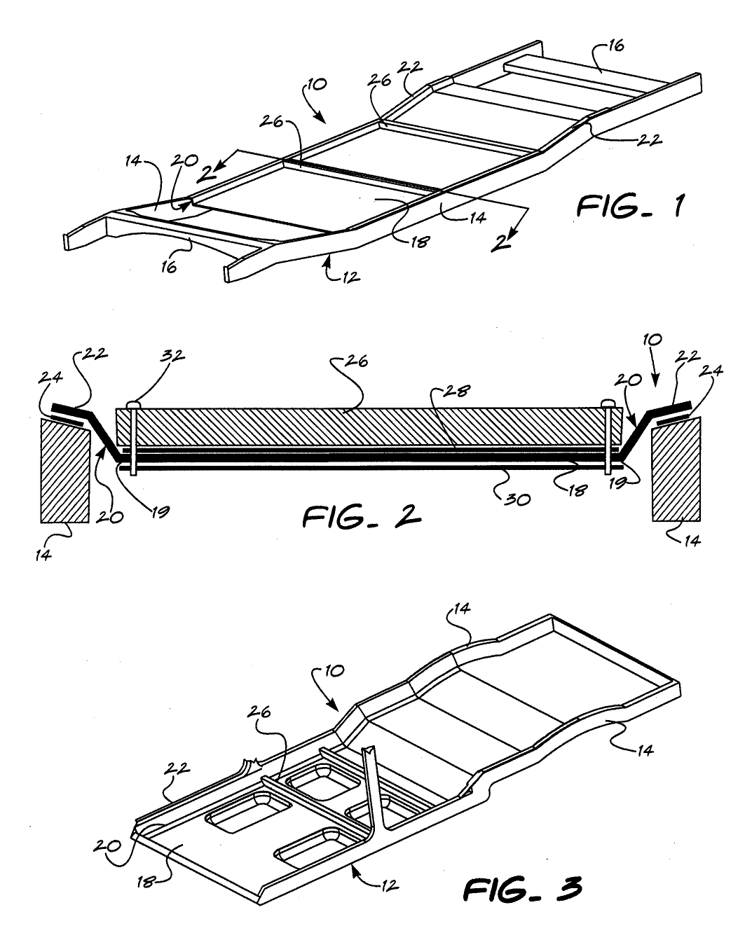

A floor module for disposition in a vehicle is generally shown at 10. The vehicle has a load bearing structure generally indicated at 12. The load bearing structure 12 may be of the rail type as shown in FIG. 1 or may be of the unitized body type as shown in FIG. 3. The load bearing structure 12 has at least a pair of side rails 14. At least one lower cross member 16 extends between the side rails 14 to provide stability to the load bearing structure 12. Typically, more than one lower cross member 16 is disposed transversely to and between side rails 14 as is well known.

As shown in FIGS. 1 and 2, the floor module 10 includes a floor section 18. The floor section 18 is configured to provide the floor for the vehicle. The floor section 18 has outside edges 19. The floor section 18 can take any contour desired. Preferably, the floor section 18 will be disposed on top of the lower cross members 16 as shown in FIG. 1. It will be appreciated that the floor section 18 may extend below the lower cross members 16. For example, as shown in FIG. 3, the floor section is contoured to provide four depressions. These depressions may provide additional space, such as, for example, for a passenger's feet. Alternatively, the depressions may provide an area to stow other vehicle components.

As best seen in FIG. 1, the floor module 10 further includes at least one side wall 20 extending transversely from the floor section 18. More specifically, a pair of side walls generally indicated at 20 extends from the outside edges 19 of floor section 18. Each side wall 20 may include a mounting flange portion 22. The side wall 20 is angled with respect to floor section 18 and the mounting flange portion 22 extends in an orientation such that it can be secured to the side rails 14. As shown, the mounting flange portion 22 extends at an angle to mate with the portion of the side rail 14 to which it will be connected. It will be appreciated that the mounting flange portion 22 can be positioned or sloped in any orientation or configuration that allows it to be connected with the associated side rail 14. Further, it is preferred that the side walls 20 extend the length of the floor section 18. However, it is not necessary that the side walls 20 be co-extensive with the length of the floor section 18. In some instances, side walls 20 may also extend from the ends of the floor section 18. In such a case, the flanges 22 on these side walls would be secured to the lower cross member 16.

The mounting flange portion 22 includes a first adhesive film 24. Preferably, the adhesive film is heat activated. However, any suitable adhesive may be used within the context of the present invention. As set forth above, the floor section 18 extends between the side rails 14 and the side walls 20 are disposed adjacent the side rails 14. The mounting flange portion 22 is adapted to engage at least a portion of the side rails 14 to secure the floor module 10 to the side rails 14 via the adhesive film 24.

The floor module 10 may further include one or more upper cross members 26. The upper cross members 26 extend between side walls 20. The upper cross members 26 preferably comprise the same material as the floor section 18 and side walls 20. However, the upper cross members 26 may comprise any suitable material. The upper cross members 26 aid in providing support for the floor module 10. Further, the upper cross members 26 provide an attachment point for attaching items to the floor section 18, such as, for example, a vehicle seat (not shown).

Each upper cross member 26 is secured to the floor section 18 in any suitable manner preferably via a suitable adhesive. More specifically, a second adhesive film 28 is disposed between the upper cross member 26 and the floor section 18. The second adhesive film 28 secures the upper cross member 26 to the floor section 18. Any suitable adhesive may be used, however, as with the first adhesive film 24, a heat activated adhesive is preferred.

At least a portion of bottom side of the floor section 18 may include a damper 30 thereon. The damper 30 is used to reduce noise and vibration at the floor section 18. The damper 30 may comprise any kind of damper, such as, for example, a damper 30 that can be applied as a liquid by spraying it on or by manual application technologies, such as, for example, by brushing or application by spatula, and cured. Alternatively, the damper 30 can comprise a damping pad that is secured such as by adhesive to the bottom side of the floor section 18 that can be used to dampen noise and vibration at the floor section 18. By way of non-limiting example, the damper 30 may comprise a water based damping material, such as BETADAMP® dampers commercially available from The Dow Chemical Company. Also, rubber based damping materials, such as BETAPHON® dampers 30 which are also commercially available from The Dow Chemical Company may be used. It will be appreciated, however, that any suitable damping material may be used for the damper 30 in the context of the present invention. It will be appreciated that the damper 30 may also be disposed on at least a portion of the side wall 20.

It is preferred that the floor section 18 and side wall 20 be made as a single, one-piece unit by compression or injection molding. Since the floor module 10 is intended to replace existing floor modules in a vehicle, the material is used to make the floor section 18 and side walls 20 preferably comprises and e-coat capable plastic material. In the most preferred embodiment, a fiber reinforced epoxy material is used. One suitable epoxy that may be used is DER 383, which is commercially available from The Dow Chemical Company. It will be appreciated that any suitable reinforcement may be used in the epoxy, such as, by way of non-limiting example, glass, carbon, natural or aramid fibers to form a composite. Additionally, the fibers may be in the form of a mat. Further, it will be appreciated that the material used to make the floor section 18 and side walls 20 can comprise any material which provides the requisite strength and which preferably has e-coat capability.

The floor module 10, when made from a filled epoxy material, and having an attached damper 30, meets current stiffness and impact requirements. Additionally, NVH concerns should also be met.

Brackets or attachment plates 34 may be connected to the side walls 20, floor section 18 or mounting flange portion 22. The brackets 34 are preferably molded at the same time and are integral with the side walls 20, floor section 18 or mounting flange portion 22. The brackets 34 provide a mounting point for mounting other vehicle components (not shown). While it is preferred that the brackets 34 be molded as part of the side walls 20, floor section 18 or mounting flange portion 22, it will be appreciated that the brackets 34 may be made separately and attached to the side walls 20, floor section 18 or mounting flange portion 22 in any suitable manner. Once such manner is by the use of an adhesive.

It is preferred that the floor module 10 be assembled off-line, that is, not at the assembly plant, and inserted as a single unit into the vehicle during the assembly process. Preferably, the floor module 10 is inserted during construction of the vehicle floor body. Once the floor section 18, side walls 20, mounting flange portion 22 and any brackets 34 are integrally formed, the first adhesive layer 24 is placed on the mounting flange portion 22. The second adhesive film 28 is placed on the floor section 18 at a point where the upper cross member 26 is to be placed. The upper cross member 26 is then placed over the second adhesive film 28. Alternatively, the second adhesive film 28 may be placed on the upper cross member 26 prior to placement of the upper cross member 26 at its appropriate location with respect to the floor section 18. A temporary securing structure comprising temporary pins 32 is placed through the upper cross member 26, second adhesive film 28, and floor section 18. The temporary pins 32 hold the floor module 10 components together while the floor module 10 is placed into the vehicle. The temporary pins 32 can be removed after the floor module 10 is secured and the vehicle's load bearing structure 12 and all the components are adhesively secured. Alternatively, the temporary pins 32 can remain as part of the floor module 10, but after all of the components are adhesively secured, the temporary pins 32 provide no further function. It will be appreciated that while the temporary securing structure is shown to be temporary pins 32, other temporary securing structure can be used to temporarily secure the components while the floor module 10 is secured in the vehicle. One such alternate structure includes the use of integrated snap features among the components. Any suitable snap arrangement may be used.

Once the floor module 10 is made as set forth above, it is inserted into the vehicle during the assembly process. Then, as the vehicle undergoes an e-coating process at an elevated temperature, the first adhesive film 24 and second adhesive film 28 are activated. That is, the heat generated during the e-coating process activates the first adhesive film 24 and second adhesive film 28 to secure the respective components. Specifically, the first adhesive film 24 secures the side wall 20, and more specifically, the mounting flange portion 22 thereof, to the side rails 14. The second adhesive film 28 secures the upper cross members 26 to the floor section 18.

It will be appreciated that while the floor module 10 is preferably a single piece that extends between the firewall to the spare wheel well as shown in FIG. 1, it may not always be feasible to have the floor module 10 be one single unit all the way from the fire wall to the spare wheel well. Typically, when a unitized body construction is used, two floor modules may be necessary in order to get the floor module 10 into the vehicle during the assembly process. In such a case, the first module may extend between the side rails 14 from the fire wall to the center console. The second floor module may extend from the center console to the spare wheel well. Otherwise, the floor module is as described.

Test plaques were made to confirm the adhesion capability of a damping material with a glass mat filled epoxy material. The epoxy used was DER 383. The following five examples show acceptable adhesion of the applied damper 30 to the bottom of the floor section 18.

### EXAMPLE 1

BETADAMP® 24 was applied by spatula to a glass mat filled epoxy. The betadamp was air dried for 16 hours then baked for 30 minutes at 140° C.

### EXAMPLE 2

BETADAMP® 24 was applied by spatula, pre-gelled for 30 minutes at 190° C. then baked for 30 minutes at 140° C.

### EXAMPLE 3

BETADAMP® 211 B was applied by spatula to a glass mat filled epoxy and baked for 30 minutes at 140° C.

### EXAMPLE 4

BETADAMP® 222 was applied by spatula to a glass mat filled epoxy and baked for 30 minutes at 140° C.

### EXAMPLE 5

BETAPHON® 2D was applied by spatula to a glass mat filled epoxy and baked for 30 minutes at 140° C.

The above examples indicate that a damper material will adequately bond to continuous fiber reinforced epoxy materials.

The invention has been described in an illustrative manner. It is to be understood that the terminology used is intended to be in the nature of words of description. Obviously many modifications and variations are possible in light of the above teachings.

What is claimed is:

1. A floor module for disposition in a vehicle having a load bearing having side rails and at least one lower cross member disposed between the side rails, said floor module comprising:
a floor section for disposition on the load bearing structure to comprise the floor of the vehicle,
at least one wall extending transversely from said floor section and adapted to be secured to the load bearing structure; and
said wall including a mounting flange portion having an adhesive layer on at least a portion thereof, said adhesive layer adapted to secure said module to the load bearing structure.

2. A floor module as set forth in claim 1 wherein said adhesive layer on said mounting flange is heat activated.

3. A floor module as set forth in claim 1 wherein said floor section and said at least one wall comprises an e-coat capable plastic material.

4. A floor module as set forth in claim 3 wherein said e-coat capable plastic material comprises an epoxy.

5. A floor module as set forth in claim 3 wherein said plastic material is reinforced.

6. A floor module as set forth in claim 3 further comprising an upper cross member adapted to be secured to said floor section, wherein said upper cross member extends between the side rails.

7. A floor module as set forth in claim 6 further comprising an adhesive layer between said upper cross member and said floor section for securing the upper cross member with said floor section.

8. A floor module as set forth in claim 7 wherein said adhesive layer is heat activated.

9. A floor module as set forth in claim 3 further comprising a damper on at least a portion of said floor section.

10. A floor module as set forth in claim 7 further comprising temporary connecting structure temporarily securing said upper cross member with said floor section.

11. A floor module as set forth in claim 10 wherein said temporary connecting structure comprises a pin.

12. A floor module as set forth in claim 10 wherein said temporary connecting structure comprises a snap.

13. A floor module as set forth in claim 3 further comprising at least one mounting bracket secured to one at least one of said floor section or said wall.

14. A floor module as set forth in claim 1 wherein said floor section and said at least one wall comprises one piece.

15. A method of constructing a floor module and securing the floor module in a vehicle having a load bearing structure having side rails and at least one lower cross member disposed between the side rails, said method comprising the steps of:
molding a floor section and at least one wall extending transversely to the floor section;
placing a heat activated adhesive film on at least a portion of the at least one wall;
placing the module in a vehicle so that the at least one wall and the adhesive film contact the load bearing structure; and
e-coating at least a portion of the module and simultaneously activating the adhesive film to thereby secure the floor module to the load bearing structure.

16. A method as set forth in claim 15 wherein said floor section and said wall are molded from an e-coat capable epoxy.

17. A method as set forth in claim 15 further comprising placing an upper cross member having an adhesive layer thereon on the floor section.

18. A method as set forth in claim 17 further comprising activating the adhesive layer on the upper cross member while e-coating at least a portion of the module.

19. A method as set forth in claim 15 further comprising applying a damper to the floor section.

20. A method as set forth in claim 17 further comprising temporarily securing the floor section and upper cross member using a pin prior to placing the module in a vehicle.

21. A method as set forth in claim 15 further comprising molding the floor section and at least one wall as one piece.
